(19) United States
(12) Patent Application Publication
(10) Pub. No.: US 2015/0075170 A1
(43) Pub. Date: Mar. 19, 2015

(54) METHOD AND SYSTEM FOR AUGMENTING THE DETECTION RELIABILITY OF SECONDARY FLAME DETECTORS IN A GAS TURBINE

(71) Applicant: General Electric Company, Schenectady, NY (US)

(72) Inventors: Alston Ilford Scipio, Mableton, GA (US); Sanji Ekanayake, Mableton, GA (US); Dale J. Davis, Greenville, SC (US); Jean-Marc Carré, Marietta, GA (US); William McEntagart, Marietta, GA (US)

(73) Assignee: General Electric Company, Schenectady, NY (US)

(21) Appl. No.: 14/029,280

(22) Filed: Sep. 17, 2013

(51) Int. Cl. F02C 9/26; G01M 15/14; F02C 3/14

(52) U.S. Cl. CPC F02C 9/263; F02C 3/14; G01M 15/14; F05D 2270/44
USPC 60/772; 60/734; 60/803; 73/112.01

(57) ABSTRACT

Systems and methods for operating a gas turbine combustion system by generating a flame detection signal are provided. A set of modeled parameters expected when there is a flame in a secondary combustion zone is calculated. A set of measured gas turbine parameters is measured. A flame validation signal based on the set of measured parameters and the set of modeled parameters is generated. The systems include a subsystem that calculates a set of modeled parameters expected when there is a flame in the secondary combustion zone and a subsystem that measures a set of measured parameters. A subsystem generates a flame validation signal based on the set of measured parameters and the set of modeled parameters.

### BACKGROUND OF THE INVENTION

The subject matter disclosed herein generally relates to methods and systems for flame detection in gas turbines, and more particularly to methods and systems for augmenting the detection reliability of secondary flame detectors in a gas turbine.

Gas turbine systems are widely utilized in fields such as power generation. A conventional gas turbine system includes a compressor, a combustor, and a turbine. In a conventional gas turbine system, compressed air is provided from the compressor to the combustor. The air entering the combustor is mixed with fuel and combusted. Hot gases of combustion flow from the combustor to the turbine to drive the gas turbine system and generate power.

In recent years, the regulatory requirements for low emissions from gas turbines have imposed strict limits on nitrous oxide emissions in power generating equipment. As requirements for gas turbine system emissions have become more stringent, one approach to meeting such requirements is to utilize lean fuel and air mixtures in a fully premixed operations mode in the combustor, to reduce emissions of, for example, NOx and CO. These combustors are known in the art as Dry Low NOx (DLN) combustion systems. These combustors typically include a plurality of primary nozzles which are ignited for low load and mid load operations of the combustor. During fully premixed operations, the primary nozzles supply fuel to feed a secondary flame. The primary nozzles typically surround a secondary nozzle that is utilized for mid load up to fully premixed mode.

DLN combustion systems typically use both a pre-mix or primary zone and a secondary zone. Reduced temperature combustion takes place in the secondary zone as a direct result of the enhanced air fuel mixing. The combustion takes place only in the secondary zone at base load, then in either or both combustion zones on a strict start-up and shut-down schedule in order to avoid hardware damage.

To control flame presence in the proper zone or zones, one must sense the flame independently in either zone. Typically, flame sensors continuously sense the presence of infrared, visible, ultraviolet or some combination of these three wavelengths of flame radiation (hereinafter sometimes collectively referenced as “light” radiation), and then announce that presence to a control system.

With some DLN systems, combustion mode transfer requires recognition and/or confirmation of the flame by the secondary flame detector. In some cases, these flame detectors may not detect flames due to fogging or damage to the optics. Failure to detect flames may result in a failed transfer during load and/or mode changes and after start, such as after water washing. Failed transfers results in trips, shutdowns, and/or continuous operation at part load.

### BRIEF DESCRIPTION OF THE INVENTION

The disclosure provides a solution to the problem of flame detector reliability in detecting a flame out condition in a secondary combustion zone of a gas turbine system, and mitigating “false trips”.

In accordance with one exemplary non-limiting embodiment, the invention relates to a method for operating a gas turbine combustion system including the steps of calculating a set of modeled parameters expected when there is a flame in the secondary combustion zone, measuring a set of measured parameters, and generating a flame validation signal based on the set of measured parameters and the set of modeled parameters.

In another embodiment, a system for operating a gas turbine combustion system is provided. The system includes a subsystem that calculates a set of modeled parameters expected when there is a flame in the secondary combustion zone. The system also includes a subsystem that measures a set of measured parameters, and a subsystem that generates a flame validation signal based on the set of measured parameters and the set of modeled parameters.

In another embodiment, a system is provided having a compressor, a combustor having a secondary combustion zone, and a turbine. The system includes a subsystem that calculates a set of modeled parameters expected when there is a flame in the secondary combustion zone, and a subsystem that measures a set of measured parameters. A subsystem that generates a flame validation signal based on the set of measured parameters and the set of modeled parameters is also included.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a schematic of a gas turbine system.

FIG. 2 is a block diagram representation of a system for generating a flame detection signal.

FIG. 3 is a flow chart of an exemplary method for detecting a flame in a secondary combustion zone.

FIG. 4 is a flow chart of an exemplary method for detecting a flame in a secondary combustion zone.

FIG. 5 is a flow chart of a method for transferring a gas turbine from a lean-lean operating mode to a premix operating mode.

### DETAILED DESCRIPTION OF THE INVENTION

As summarized above, embodiments of the present invention encompass systems and method for operating a gas turbine system by generating a flame validation signal based on comparing a set of modeled parameters to a set of measured parameters.

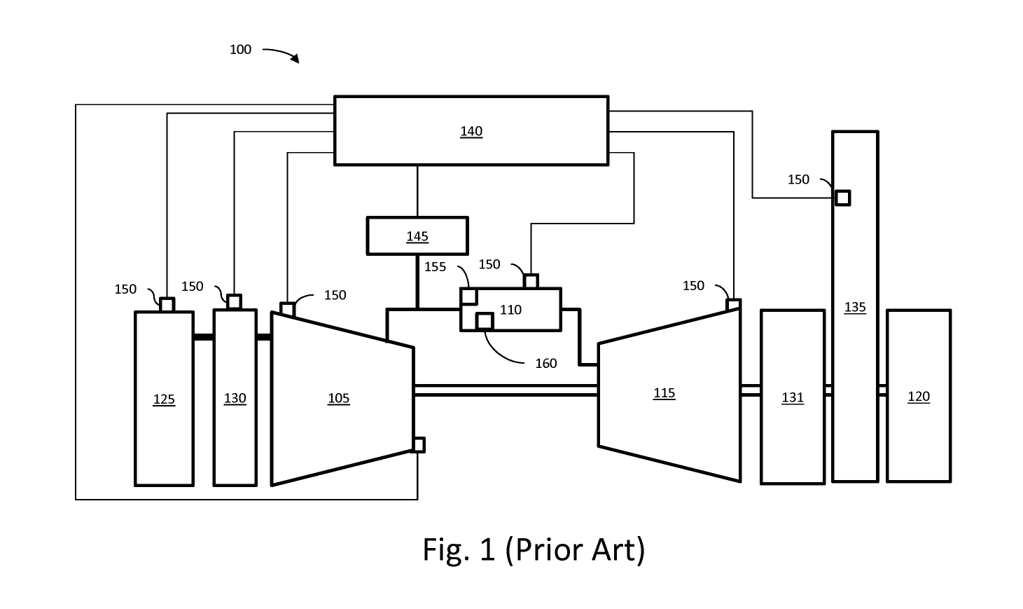

Referring now to the drawings, FIG. 1 illustrates a simplified, schematic depiction of one embodiment of a gas turbine system 100. In general, the gas turbine system 100 may include a compressor 105, one or more combustor(s) 110 and a turbine 115 drivingly coupled to the compressor 105. During operation of the gas turbine system 100, the compressor 105 supplies compressed air to the combustor(s) 110. The compressed air is mixed with fuel and burned within the combustor(s) 110. Hot gases of combustion flow from the combustor(s) 110 to the turbine 115 in order to turn the turbine 115 and generate work, for example, by driving a generator 120. The combustor(s) 110 may comprise a can combustor having a row of individual combustor cans (not shown) in which combustion gases are separately generated and collectively discharged.

Additionally, the gas turbine system 100 may include an inlet duct 125 configured to feed ambient air and possibly injected water to the compressor 105. The inlet duct 125 may have ducts, filters, screens and/or sound absorbing devices that contribute to a pressure loss of ambient air flowing through the inlet duct 125 and into one or more inlet guide vanes 130 of the compressor 105. The gas turbine system 100 may include a heat recovery steam generator system (HRSG 131). The HRSG 131 is an energy recovery heat exchanger that recovers heat from a hot gas stream. It produces steam that can be used in a process (cogeneration) or used to drive a steam turbine (not shown). Moreover, the gas turbine system 100 may include an exhaust duct 135 configured to direct combustion gases from the outlet of the turbine 115. The exhaust duct 135 may include sound absorbing materials and emission control devices.

Moreover, the gas turbine system 100 may also include a controller 140. In general, the controller 140 may comprise any suitable processing unit (e.g., a computer or other computing device) capable of functioning as described herein. For example, in several embodiments, the controller 140 may comprise a General Electric Company SPEEDTRONIC™ Gas Turbine Control System. The controller 140 may generally include one or more processors that execute programs, such as computer readable instructions stored in the controller's memory, to control the operation of the gas turbine system 100 using sensor inputs and instructions from human operators. For example, the programs executed by the controller 140 may include scheduling algorithms for regulating fuel flow to the combustor(s) 110. As another example, the commands generated by the controller 140 may cause actuators on the gas turbine to, for example, adjust valves between the fuel supply and the combustor(s) 110 that regulate the flow, fuel splits and type of fuel flowing to the combustor(s) 110, adjust the angle of the inlet guide vanes 130 of the compressor 105, and/or to activate other control settings for the gas turbine system 100.

The scheduling algorithms may enable the controller 140 to maintain, for example, the NOx and CO emissions in the turbine exhaust to within certain predefined emission limits, and to maintain the combustor firing temperature to within predefined temperature limits. Thus, it should be appreciated that the scheduling algorithms may utilize various operating parameters as inputs. The controller 140 may then apply the algorithms to schedule the gas turbine system 100 (e.g., to set desired speed to support load requirement, turbine exhaust temperatures and combustor fuel splits) so as to satisfy performance objectives while complying with operability boundaries of the gas turbine system 100.

Referring still to FIG. 1, a fuel control system 145 may be configured to regulate the fuel flowing from a fuel supply to the combustor(s) 110, the split between the fuel flowing into primary and secondary fuel nozzles, and/or the amount of fuel mixed with secondary air flowing into the combustion chamber of the combustor(s) 110. The fuel control system 145 may also be adapted to select the type of fuel for the combustor(s) 110. It should be appreciated that the fuel control system 145 may be configured as a separate unit or may comprise a component of the controller 140.

Additionally, in several embodiments, operation of the gas turbine system 100 may be monitored by a plurality of sensors 150 detecting various operating parameters of the gas turbine system 100, the generator 120 and/or the ambient environment. In many instances, a plurality of sensors 150 may be utilized to measure the same operating parameters. For example, a plurality of sensors 150 (redundant temperature sensors) may monitor the ambient air temperature, compressor inlet temperature, compressor discharge temperature, turbine exhaust gas temperature, fuel temperature and/or other temperatures of the fluids flowing through the gas turbine system 100. Similarly, a plurality of sensors 150 (redundant pressure sensors) may monitor ambient air pressure and static and dynamic pressure levels at the compressor inlet and outlet, at the turbine exhaust and at other locations at which fluids are flowing through the gas turbine system 100. Moreover, the plurality of sensors 150 may include redundant humidity sensors (e.g., wet and dry bulb thermometers) to measure ambient specific humidity within the inlet duct 125 of the compressor 105. Further, the plurality of sensors 150 may also comprise flow sensors (e.g., fuel flow sensors, air flow sensors, inlet bleed heat flow sensors, other mass flow sensors and/or the like), speed sensors (e.g., turbine shaft speed sensors), flame detector sensors, valve position sensors, guide vane angle sensors and/or the like that sense various other parameters pertinent to the operation of the gas turbine system 100.

As indicated above, in several embodiments of the present subject matter, one or more operating parameters of the compressor 105 (e.g., compressor mass flow, compressor pressure ratio and/or the like) may be monitored by the controller 140. Thus, a plurality of sensors 150 may be disposed at various locations within and/or adjacent to the compressor 105 to allow such operating parameters to be monitored. For example, the plurality of sensors 150 may include one or more pressure sensors that may be disposed within and/or adjacent to the compressor inlet and compressor outlet to permit the compressor pressure ratio to be monitored. Similarly, the plurality of sensors 150 may include one or more flow sensors that may be disposed within and/or adjacent to the compressor 105 to allow the mass flow through the compressor 105 to be measured.

It should also be appreciated that, as used herein, the term “parameter” refers to an item(s) that may be used to define the operating conditions of the gas turbine system 100, such as temperatures, pressures, air flows, gas flows, gas concentrations, turbine speeds, humidity and the like at defined locations in the gas turbine system 100. Some parameters may be measured (e.g., using sensors 150) and, thus, may be directly known. Other parameters may be estimated or modeled using the gas turbine model and, thus, may be indirectly known. The measured and/or modeled parameters may generally be used to represent a given turbine operating state.

Current gas turbine combustion systems producing low nitrous oxide emissions typically use both a pre-mix or primary zone and a secondary zone where reduced temperature combustion takes place as a direct result of the enhanced air fuel mixing. The combustion takes place only in the secondary zone at base load, then in either or both combustion zones on a strict start-up and shut-down schedule in order to avoid hardware damage. To control flame presence in the proper zone or zones, one must sense the flame independently in either zone. To sense the flame in the primary and secondary combustion zone, the combustor(s) 110 may be provided with a primary flame detection sensor 155 and a secondary flame detection sensor 160. Typically, primary flame detection sensor 155 and secondary flame detection sensor 160 continuously sense the presence of light radiation, and then announce that presence to a control system which then acts immediately when the flame improperly appears in either combustion zone. The primary flame detection sensor 155 and the secondary flame detection sensor 160 must be physically located some distance away from the intense heat generated by the combustion chambers while retaining high sensitivity to the generated radiation.

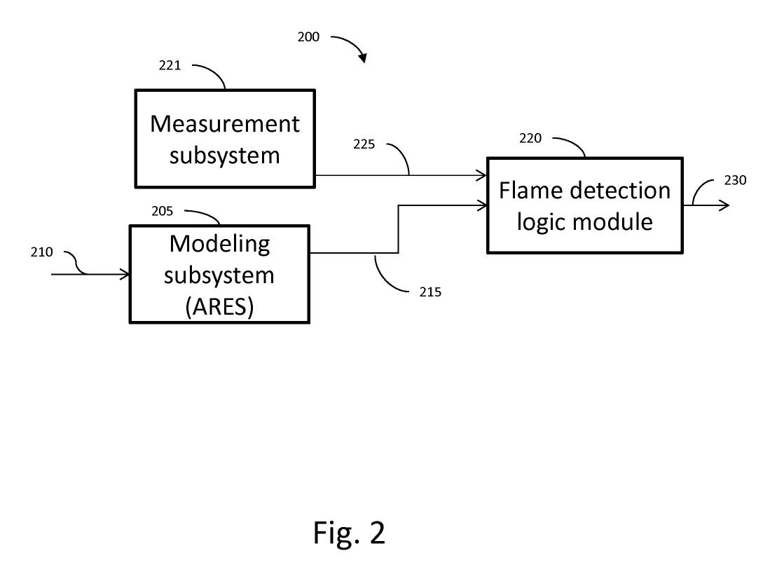

Illustrated in FIG. 2 is a high-level block diagram of a system for generating a flame detection signal (SGFDS) 200. The SGFDS 200 includes a modeling subsystem 205 that calculates a set of modeled parameters expected when there is a flame in the secondary combustion zone. The modeling subsystem 205 may comprise an adaptive real-time engine simulation (ARES) model configured to model electronically, in real-time, several operating parameters of the gas turbine system 100. As shown in FIG. 1, the gas turbine system 100 has a set of observable parameters that are herein referred to as ARES inputs 210. The ARES inputs 210 may be directly measured by sensors 150 and may include (without limitation): ambient conditions, such as the ambient air pressure (PAMB) and ambient air temperature (TAMB), inlet pressure differential (DP-inlet) (i.e., the pressure differential between the ambient air pressure and the pressure of the air exiting the inlet duct 125 and entering the compressor 105), exhaust pressure differential (DP-exhaust) (i.e., the pressure differential between the ambient air pressure and the pressure of the exhaust gases flowing through the exhaust duct 135), specific humidity of the ambient air (SPHUM), compressor inlet temperature (CTIM), angle of the inlet guide vanes 130 (IGV), inlet bleed heat flow (IBH) (i.e., the percentage of the compressor flow redirected to the compressor inlet), flow rate of the fuel supplied to the combustor(s) 110 (W-FUEL), temperature of the fuel (T-FUEL), rotational speed of the turbine shaft (SPEED), effective area of the stage one nozzle of the turbine 115 (S1NA) and power factor of the generator 120 (PFACT), among others.

The listed ARES inputs 210 are exemplary, and are provided merely to illustrate one example of sensed inputs that may be collected. Thus, it should be appreciated that the specific ARES inputs 210 of the modeling subsystem 205 may vary depending on, for example, the type of controller 140 used, the specific modeling subsystem 205 applied and/or the sensors 150 available at a particular gas turbine installation. In other words, it should also be appreciated that the term “ARES” does not imply or require that each and every one of the measured parameters described above must be input into the gas turbine model disclosed herein or that any such modeling subsystem 205 must have these inputs. Thus, the ARES inputs 210 may only include some of the measured parameters described above and/or may include other measured operating parameters of the gas turbine system 100. The term ARES inputs 210 merely indicates that, for the particular embodiment of the modeling subsystem 205 disclosed herein, these inputs may be taken from measurements of actual turbine conditions and may be applied as inputs to the modeling subsystem 205.

As shown in FIG. 2, the ARES inputs 210 may be applied by the modeling subsystem 205 to generate modeled output values 215 corresponding to predicted operating parameters of the gas turbine system 100. For example, modeled output values may include modeled turbine exhaust temperature (TTXM_{mod}), modeled compressor discharge pressure (CPD_{mod}), and modeled expected turbine torque (τ_{mod}), among others. The modeled output values 215 may be calculated based on the assumption that there is a flame in the secondary combustion zone. The modeled output values 215 are applied as inputs to a flame detection logic module 220. The SGFDS 200 also includes a measurement subsystem 221 that measures and provides measured inputs 225. Measured inputs 225 may include measurements from combustion dynamics monitoring probes (CDM), turbine exhaust temperatures (TTXM), fuel stroke reference command (FSR), compressor discharge pressure (CPD), swirl chart logic and measurements from gas pressure transmitters (FPG2), among others. The flame detection logic module 220 generates a flame validation signal 230 based on the measured parameters and the modeled parameters. The flame validation signal 230 indicates if the flame is on or off.

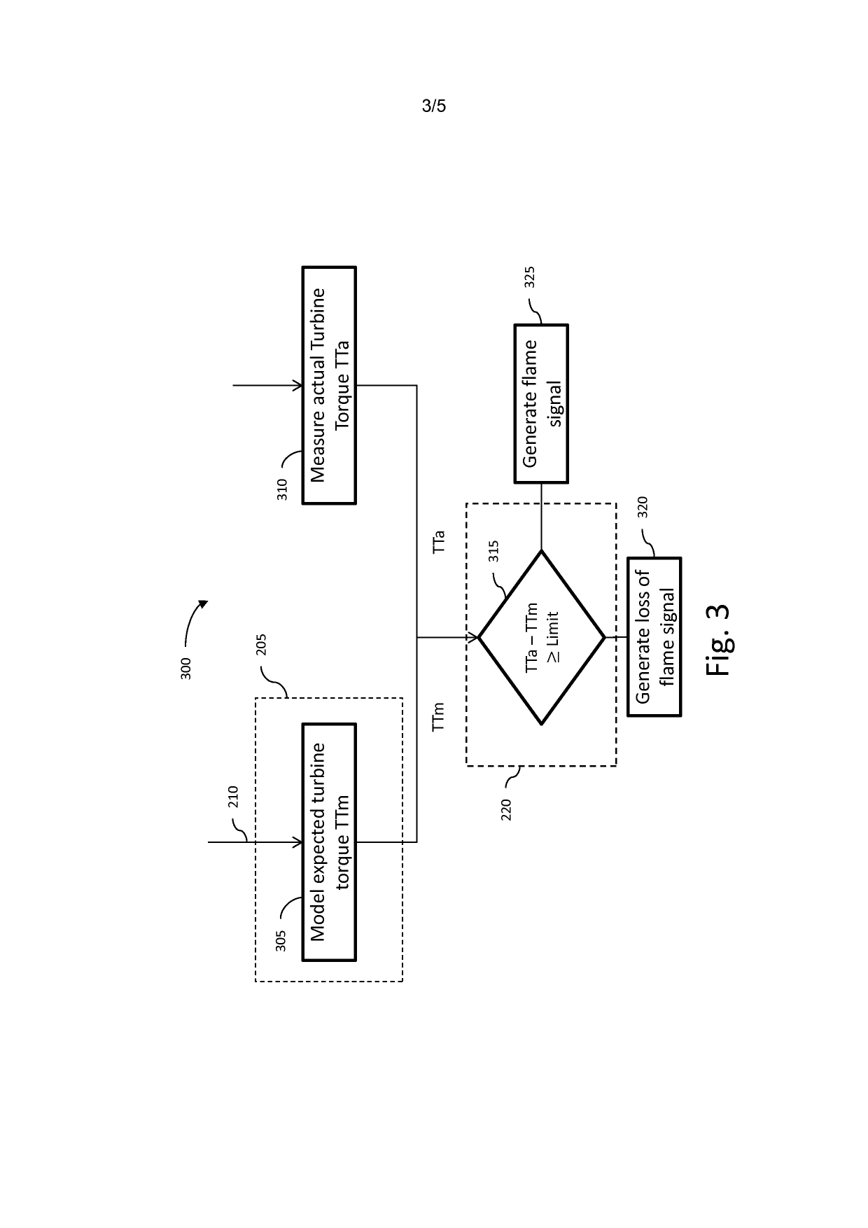

Illustrated in FIG. 3 is a flow chart of an exemplary method 300 of generating a flame detection signal in a secondary combustion zone.

In this example, in step 305, the method 300 models the turbine torque and provides a modeled turbine torque value TTm. The modeled turbine torque value is modeled by the modeling subsystem 205 using ARES inputs 210.

In step 310, the method 300 measures the actual turbine torque (TTa). The actual turbine torque TTa may be derived from measurements of current transformers (CT) and potential transformers (PT) associated with the generator 120. Compressor shaft acceleration measurements (TNHA) may be used to correct real power during grid transients using a TNHA based transient inertia model.

In step 315, the method 300 determines whether the difference between the modeled turbine torque TTm and the actual turbine torque TTa is greater than or equal to a predetermined limit.

If the difference between the modeled turbine torque and the actual turbine torque is greater than or equal to the predetermined limit, the method proceeds to the next step 320 that generates a loss of flame signal. Alternately, if the difference between the modeled turbine torque and the actual turbine torque is less than the predetermined limit, the method proceeds to the next step 325 that generates a flame on signal.

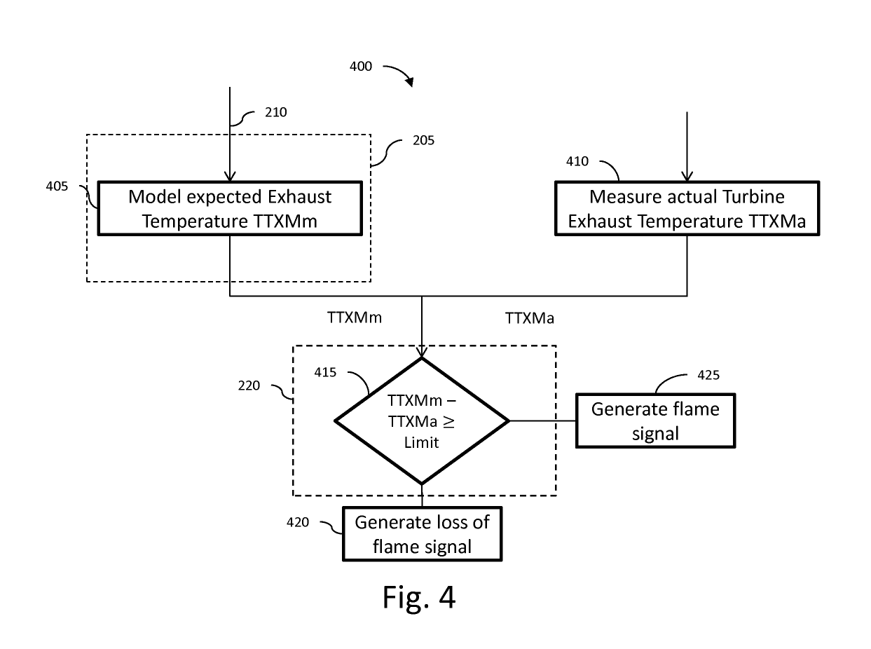

Illustrated in FIG. 4 is a flow chart of an exemplary method 400 for generating a flame detection signal in a secondary combustion zone.

In step 405, the method 400 models the expected exhaust temperature TTXMm based on no fuel consumption. Modeling of the expected exhaust temperature TTXMm is accomplished using the ARES inputs 210 and the modeling subsystem 205.

In step 410, the method 400 measures the actual turbine exhaust temperature TTXMa.

In step 415, the method 400 determines if the difference between the modeled exhaust temperature TTXMm and the actual exhaust temperature TTXMa is greater than or equal to a predetermined limit. This step may take place in the flame detection logic module 220.

If the difference between the modeled exhaust temperature TTXMm and the actual exhaust temperature TTXMa is greater than or equal to the predetermined limit, the method proceeds to the next step 420 that generates a loss of flame signal. Alternately, if the difference between the modeled exhaust temperature TTXMm and the actual exhaust temperature TTXMa is less than the predetermined limit, the method proceeds to the next step 425 that generates a flame on signal.

Other modeled and actual parameters may be used to generate a flame validation signal 230 or to indicate a loss of flame.

For example, a plurality of differential pressure transducers may be added to a combustion dynamics monitoring system. One may measure the combustion chamber pressure in the combustor(s) 110 relative to compressor discharge pressure. If the measured differential pressure is not greater than the minimum expected value based on load, one may count the combustion chamber as not having a flame.

Another way to indicate a loss of flame signal is to compare a model based value of active power derived from the modeling subsystem 205 against a sensor based active power. The sensor based active power may be derived from a high speed PGEN board (a steam turbine unload balance controller used for large steam turbine power load unbalance function). If the sensor based active power is less than the model based value of active power, then the system may generate a flame out signal.

The flame detection methodology set out herein may be used to detect a flame during startup as a pre-condition for continuing the startup process. One may use the temperature difference between the compressor discharge temperature (CTD) and the combustion reference temperature (C_CRT) that is an established reference value. Standard flow rate algorithms may be used to account for residual heat stored in the hot gas path. Spread algorithms (at a higher level) may be used to account for scenarios where multiple combustion chambers are flamed out.

In another example, one may use a spread algorithm to detect limited flame out. One may also use a compressor discharge temperature to exhaust temperature algorithm with flow compensation to detect bulk flame out.

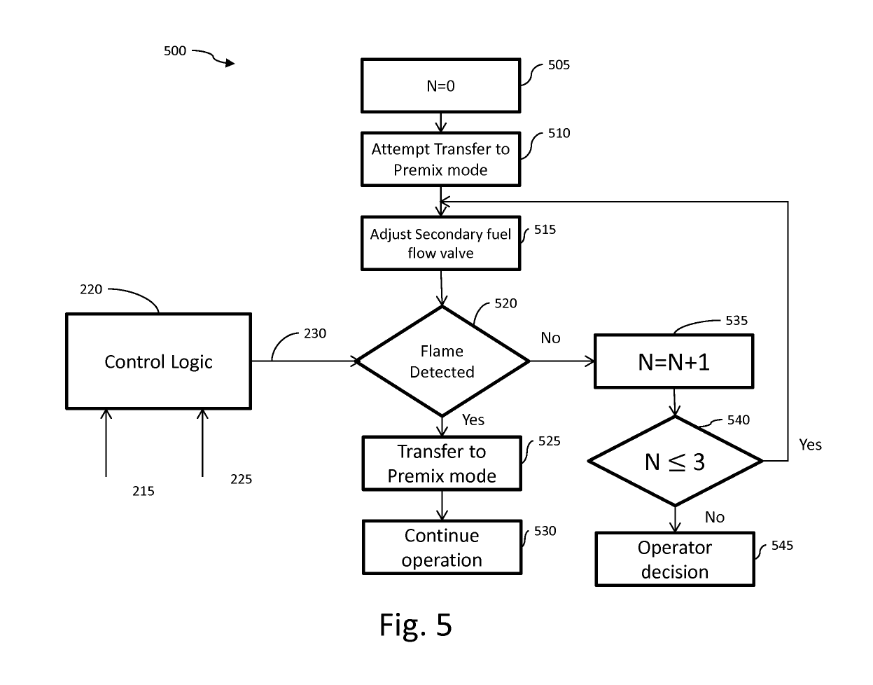

Illustrated in FIG. 5 is a flow chart of a method 500 for transferring a gas turbine from a lean-lean operating mode to a premix operating mode.

In step 505, the method 500 sets a counter or timer to zero.

In step 510, the method 500 attempts a transfer to premix mode.

In step 515, the method 500 adjusts the secondary fuel flow valve.

In step 520, the method determines whether a flame has been detected. The indication of flame detection is based on the operation of flame detection logic module 220 that compares the modeled output values 215 to the measured inputs 225 and provides the flame validation signal 230.

In step 525, if a flame is detected, then the method 500 transfers the gas turbine to a premix operating mode.

In step 530, the method 500 continues the gas turbine operation in the premix operating mode.

In step 535, if a flame has not been detected, the method 500 adds an increment to the counter or timer N so that N=N+1.

In step 540, the method 500 determines if the counter is below an established threshold (e.g. N≦3). If the counter is below the established threshold, the method 500 adjusts the secondary valve (step 515) and tests again to determine if there is a flame.

If the counter exceeds the predetermined threshold (e.g. N=4), then in step 545 the method 500 alerts the operator to make a decision while still maintaining the gas turbine system 100 in the lean-lean mode.

Flame detection may be used to detect total loss of flame during operation to account for the possibility that all combustors flame out at the same time and no high exhaust spread is apparent. Additionally, flame detection may be used to detect flame on condition during startup as a pre-condition for continuing the start process. Flame detection may also be used to detect flame off condition during shutdown to determine the point at which it is necessary to close the valves.

Where the definition of terms departs from the commonly used meaning of the term, applicants intend to utilize the definitions provided below, unless specifically indicated.

The terminology used herein is for the purpose of describing particular embodiments only and is not intended to be limiting of the invention. Where the definition of terms departs from the commonly used meaning of the term, applicants intend to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A method for operating a gas turbine combustion system comprising:
calculating a set of modeled parameters expected when there is a flame in a secondary combustion zone;
measuring a set of measured parameters; and
generating a flame validation signal based on the set of measured parameters and the set of modeled parameters.

2. The method of claim 1, wherein the set of measured parameters comprises at least one selected from among a group comprising measurements from combustion dynamics monitoring probes, turbine exhaust temperature measurements, compressor discharge pressure measurements, swirl chart logic, and gas pressure transmitter measurements.

3. The method of claim 1, wherein calculating a modeled parameter comprises calculating an expected turbine torque, and wherein the set of measured parameters is an actual turbine torque.

4. The method of claim 1, wherein calculating the set of modeled parameters comprises calculating an expected exhaust temperature, and wherein measured parameter is an actual exhaust temperature.

5. The method of claim 1, further comprising:
attempting a mode transfer; and
adjusting a secondary fuel valve if the flame validation signal indicates that there is no flame in the secondary combustion zone.

6. The method of claim 5, further comprising:
determining whether the secondary fuel valve has been adjusted a predetermined number of times; and
if the secondary fuel valve has been adjusted the predetermined number of times then stopping further attempts at mode transfer.

7. The method of claim 5, wherein attempting a mode transfer comprises attempting a transfer from a lean-lean operating mode to a premix operating mode.

8. The method of claim 1, wherein calculating a set of modeled parameters comprises calculating a set of modeled parameters using adaptive real-time engine simulation model.

9. A system for operating a gas turbine combustion system comprising:
a subsystem that calculates a set of modeled parameters expected when there is a flame in a secondary combustion zone;
a subsystem that measures a set of measured parameters; and
a subsystem that generates a flame validation signal based on the set of measured parameters and the set of modeled parameters.

10. The system of claim 9, wherein the set of measured parameters comprises at least one selected from among a group comprising measurements from combustion dynamics monitoring probes, turbine exhaust temperature measurements, compressor discharge pressure measurements, swirl chart logic, and gas pressure transmitter measurements.

11. The system of claim 9, wherein the subsystem that calculates a modeled parameter comprises a subsystem that calculates an expected turbine torque, and wherein the subsystem that measures a set of measured parameters comprises a subsystem that measures an actual turbine torque.

12. The system of claim 9, wherein the subsystem that calculates a modeled parameter comprises a subsystem that calculates an expected exhaust temperature and wherein the subsystem that measures a set of measured parameters comprises a subsystem that measures an actual exhaust temperature.

13. The system of claim 9, further comprising:
a subsystem that attempts a mode transfer; and
a subsystem that adjusts a secondary fuel valve if the flame validation signal indicates that there is no flame in the secondary combustion zone.

14. The system of claim 13, further comprising:
a subsystem that determines whether the secondary fuel valve has been adjusted a predetermined number of times; and
a subsystem that stops further attempts at a mode transfer if the secondary fuel valve has been adjusted the predetermined number of times.

15. The system of claim 13, wherein the subsystem that attempts a mode transfer comprises a subsystem that attempts a transfer from a lean-lean operating mode to a premix operating mode.

16. The system of claim 9, wherein the subsystem that calculates a set of modeled parameters comprises a subsystem that calculates a set of modeled parameters using adaptive real-time engine simulation model.

17. A system comprising:
a compressor;
a combustor having a secondary combustion zone;
a turbine;
a subsystem that generates a flame validation signal based on a set of modeled parameters and a set of measured parameters.

18. The system of claim 17, further comprising a mechanical load coupled to the turbine.

19. The system of claim 18, further comprising a heat recovery steam generator coupled with the turbine.

20. The system of claim 19, further comprising a distributed plant control system.
